(19) United States
(12) Patent Application Publication
(10) Pub. No.: US 2024/0337270 A1
(43) Pub. Date: Oct. 10, 2024

(54) GUIDE STRUCTURE FOR AIR-SUCTION NOZZLE

(71) Applicant: Guangdong Roman Technology Co., Ltd., Dongguan (CN)

(72) Inventors: Gang Li, Dongguan (CN); Youchun Yan, Dongguan (CN)

(21) Appl. No.: 18/390,012

(22) Filed: Dec. 20, 2023

Related U.S. Application Data
(63) Continuation of application No. PCT/CN2023/087777, filed on Apr. 12, 2023.

(30) Foreign Application Priority Data
Apr. 6, 2023 (CN) 2023207547894

(51) Int. Cl. F04D 29/40; F04D 25/10

(52) U.S. Cl. CPC F04D 29/40; F04D 25/10; A45D 20/00

(57) ABSTRACT

Disclosed is a guide structure for an air-suction nozzle, including a main body and guide combs built in the main body, where the main body is provided with a plurality of first air outlets, and a plurality of transverse guide fins are formed along a length direction the guide combs. One transverse guide fin corresponds to one first air outlet, and the transverse guide fins are configured to limit the turbulent air flow between different first air outlets. In the present disclosure, the guide combs are arranged to guide and divert the air flow entering the main body, and the transverse guide fins restrict the turbulent air flow between different first air outlets, resulting in that the air flow from each first air outlet is more even.

### TECHNICAL FIELD

The present disclosure relates to the technical field of nozzles, and particularly relates to a guide structure for an air-suction nozzle.

### BACKGROUND ART

A hair dryer nozzle usually refers to an air gathering or guiding device on an air outlet of a hair dryer (or an air blower). An existing nozzle structure is simple, and generally a plurality of air outlets are arranged along a central axis of a main body of a nozzle. However, the inventor, during use, found that air flow from each air outlet after air enters an air inlet channel is neither even nor concentrated, easily leading to problems such as hair sticking-out, or loud noise, thus needing improvement.

### SUMMARY

In view of the deficiencies in the prior art, an objective of the present disclosure is to provide a guide structure for an air-suction nozzle.

In order to achieve the above objective, the present disclosure provides the following technical solution: a guide structure for an air-suction nozzle, including a main body and guide combs built in the main body, where the main body is provided with a plurality of first air outlets, and a plurality of transverse guide fins are formed along a length direction the guide combs. One transverse guide fin corresponds to one first air outlet, and the transverse guide fins are configured to limit the turbulent air flow between different first air outlets;
a plurality of the guide combs are arranged, the main body is provided with a plurality of air outlet areas arranged side by side, each air outlet area is provided with a plurality of the first air outlets arranged side by side, at least one guide comb is arranged in one air outlet area, and one first air outlet at least corresponds to one transverse guide fin; and shunting barrier strips are arranged on both left and right sides of each air outlet area, and two adjacent shunting barrier strips form an inner buckle-type accommodating slot for accommodating the guide combs.

In a further technical solution, the guide combs are provided with longitudinal guide connecting strips, and the transverse guide fins are connected to the longitudinal guide connecting strips.

In a further technical solution, the number of the longitudinal guide connecting strips is configured to be one or more, and when the number of the longitudinal guide connecting strips is arranged to be one, a plurality of the transverse guide fins can be distributed on both sides or one side of the longitudinal guide connecting strip; and when a plurality of the longitudinal guide connecting strips are arranged, a plurality of the transverse guide fins can be distributed between the longitudinal guide connecting strips.

In a further technical solution, one end of the main body is configured as an air inlet end, a spacing between the transverse guide fins on the two opposite guide combs near the air inlet end is configured to be L, and the spacing between the transverse guide fins on the two opposite guide combs far from the air inlet end is configured to be L′, where L>L′.

In a further technical solution, the transverse guide fins are in a shape of an arc bending upward.

In a further technical solution, the main body includes main housings and choke assemblies, where the main housing is provided with a first air inlet channel and second air outlets connected to the first air inlet channel, and the choke assembly is provided with the first air outlets and a second air inlet channel connected to the first air outlets. The guide combs are built in the second air inlet channel of the choke assembly, and the choke assembly is arranged in the first air inlet channel of the main housing.

In a further technical solution, the choke assembly can be rotatably installed in the first air inlet channel of the main housing, and the rotating choke assembly is capable to block a left or right side of the second air outlet, so that air flows out from a right or left side of the second air outlet.

In a further technical solution, a first inclined air guide surface of the choke assembly is formed at a position of the first air outlet, and the first inclined air guide surface includes a first air guide slope configured for guiding air to flow out from a left side of the first air outlet and/or a second air guide slope configured for guiding air to flow out from a right side of the first air outlet.

In a further technical solution, a flow choking surface of the choke assembly is formed at the position of the first air outlet, and the flow choking surface includes a first flow choking surface located on an upper side of the first air outlet and/or a second flow choking surface located on a lower side of the first air outlet.

In a further technical solution, the first flow choking surface and the second flow choking surface form an inverted V-shape, so that the air flowing out of the first air outlet spirals around a wall surface of the main body towards the air inlet end.

In a further technical solution, a first air outlet slope configured for guiding air to flow out from the left side of the second air outlet and/or a second air outlet slope configured for guiding air to flow out from the right side of the second air outlet are formed at the position of the second air outlet of the main housing.

In a further technical solution, when a plurality of the guide combs are inserted and fixed in the accommodating slot, centers of end walls of the plurality of the guide combs far from the air inlet end are left empty and spliced to form a clearance hole site for a screw rod to pass through.

After the above structure is employed, compared with the prior art, the present disclosure has the following advantages:
in the present disclosure, the guide combs are arranged to guide and divert the air flow entering the main body, and the transverse guide fins restrict the turbulent air flow between different first air outlets, resulting in that the air flow from each first air outlet is more even and noise is reduced.

### BRIEF DESCRIPTION OF THE DRAWINGS

The present disclosure will be further described below with reference to the accompanying drawings and embodiments.

FIG. 1 is a schematic diagram of a breakdown structure of the present disclosure.

FIG. 2 is a schematic diagram of a structure formed after assembling a plurality of guide combs.

FIG. 3 is a schematic diagram of various embodiments of guide combs.

FIG. 4 is schematic diagram of a structure formed after assembling guide combs in a choke assembly.

FIG. 5 is a schematic diagram of a structure of a choke assembly.

FIG. 6 is a schematic diagram of an enlarged structure of part A in FIG. 5.

FIG. 7 is a schematic diagram of a structure of a main housing.

FIG. 8 is a locally enlarged schematic diagram of a first direction of air flow after a choke assembly is installed in a main housing.

FIG. 9 is a locally enlarged schematic diagram of a second direction of air flow after a choke assembly is installed in a main housing.

FIG. 10 is a schematic diagram of a guide direction of a flow choking surface at an air outlet of a choke assembly.

FIG. 11 is a schematic diagram of projection of two opposite guide combs.

FIG. 12 is a sectional view of guide combs assembled in a choke assembly.

FIG. 13 is a partial sectional view of guide combs assembled in a choke assembly.

FIG. 14 is a schematic diagram of an air flow direction when a main housing is provided with only a first air outlet slope or a second air outlet slope, and a choke assembly is provided with only a first air guide slope or a second air guide slope.

FIG. 15 is a schematic diagram of an air flow direction when a main housing is provided with only a first air outlet slope or a second air outlet slope, and a choke assembly is provided with both a first air guide slope and a second air guide slope.

FIG. 16 is a schematic diagram showing an air flow direction in two different changing states when a main housing is provided with both a first air outlet slope and a second air outlet slope, a choke assembly is provided with both a first air guide slope and a second air guide slope, and the main housing and the choke assembly can move relative to each other.

FIG. 17 is a cross-sectional projection diagram of guide combs assembled in a choke assembly with only two adjacent shunt rings kept.

Reference numerals in figures:
1—guide comb, 2—main housing, 3—choke assembly, 11—avoidance hole site, 100—longitudinal guide connecting strip, 101—transverse guide fin, 102—shunt ring, 20—first air inlet channel, 21—second air outlet, 22—first air outlet slope, 23—second air outlet slope, 30—first air outlet, 31—second air inlet channel, 32—shunting barrier strip, 33—first air guide slope, 34—second air guide slope, 35—first flow choking surface, 36—second flow choking surface, and 320—accommodating slot.

### DETAILED DESCRIPTION OF THE EMBODIMENTS

The following are merely preferred embodiments of the present disclosure, and are not intended to limit the scope of protection of the present disclosure.

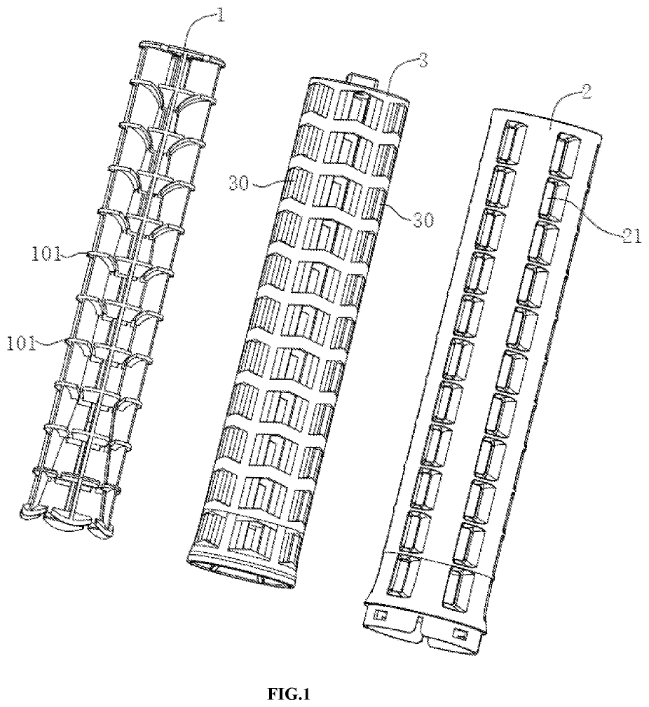

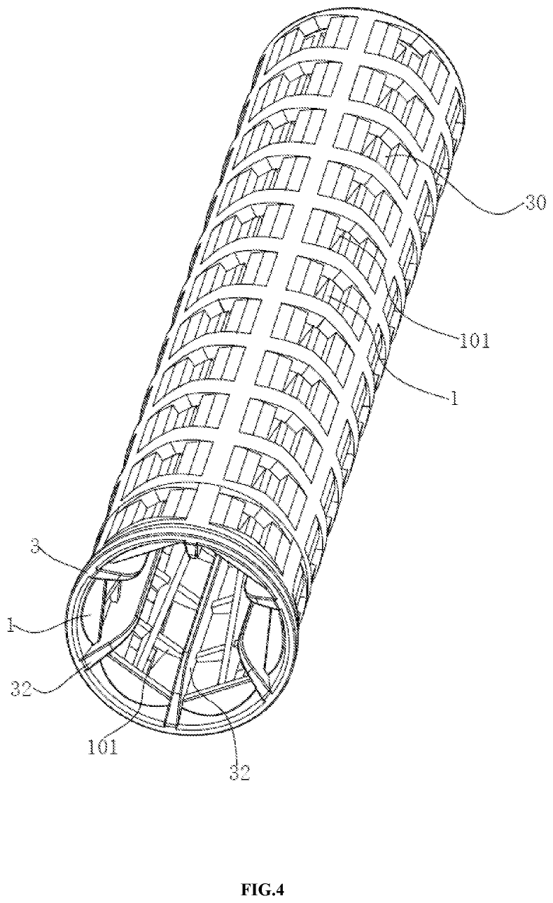

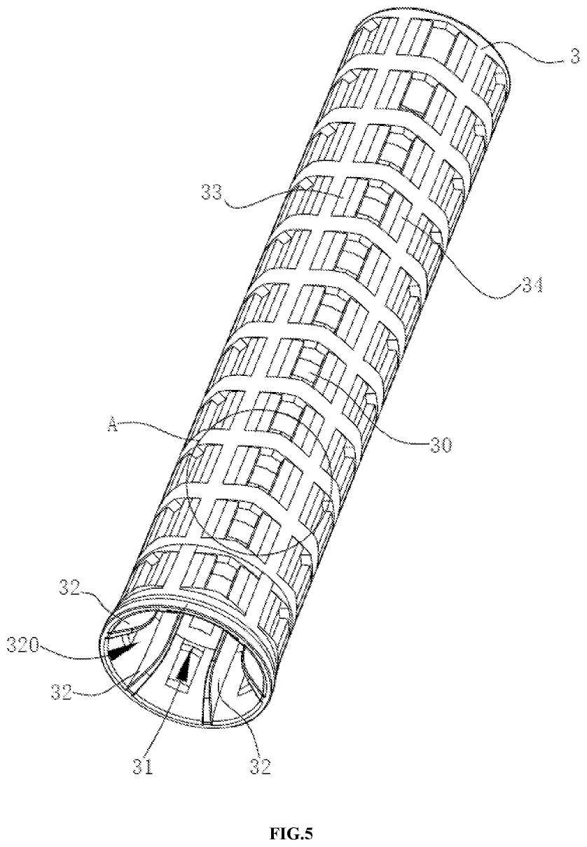

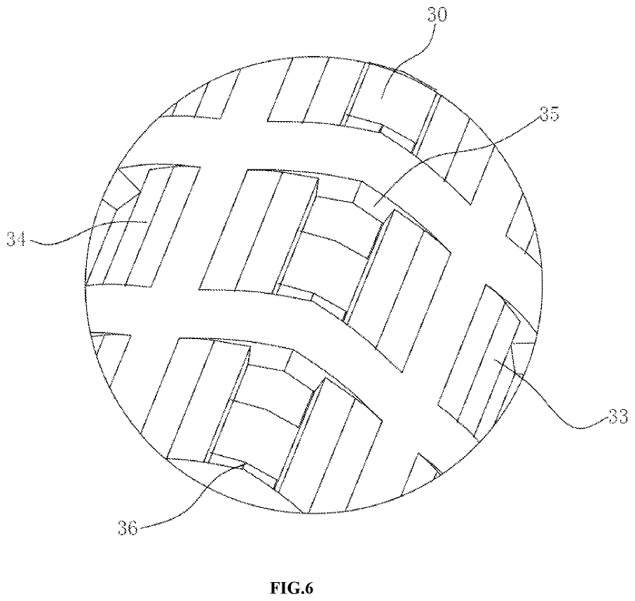

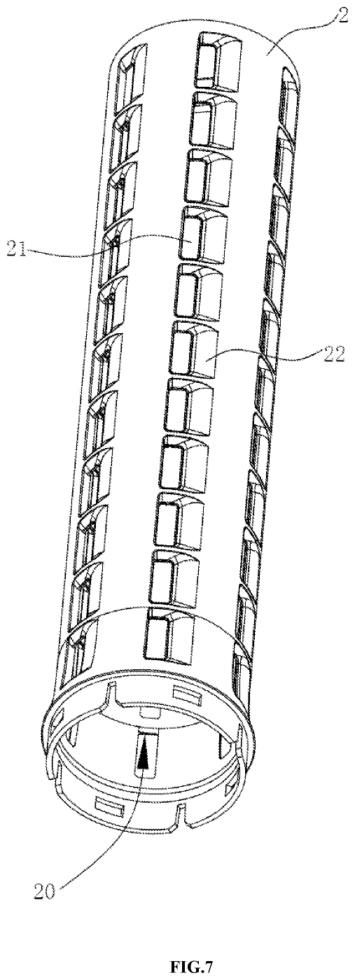

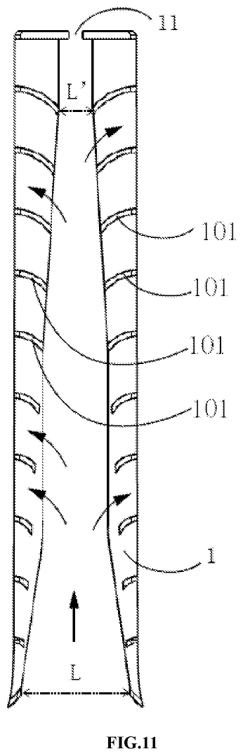

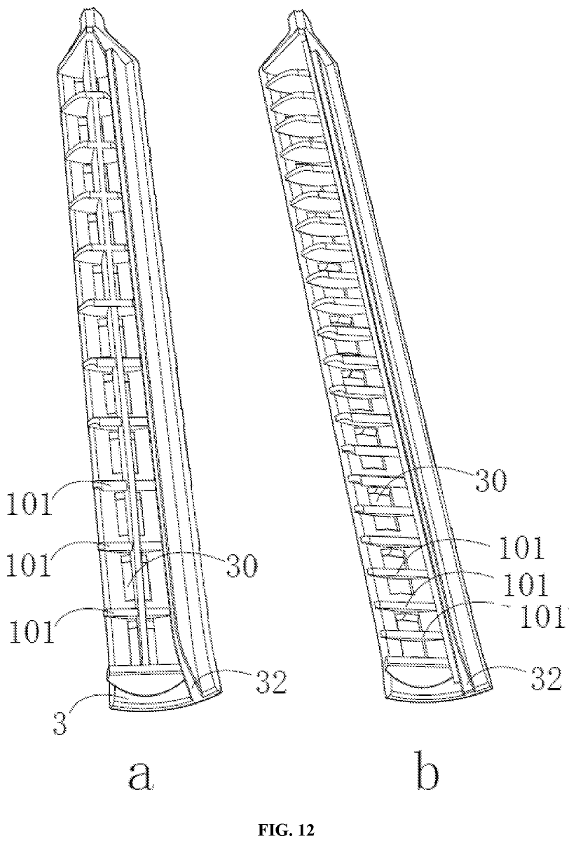

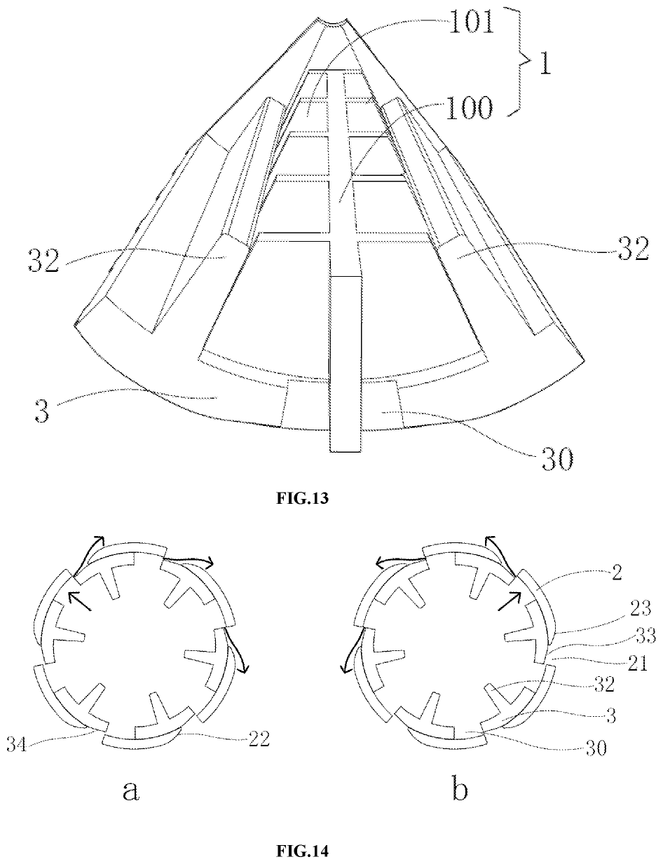

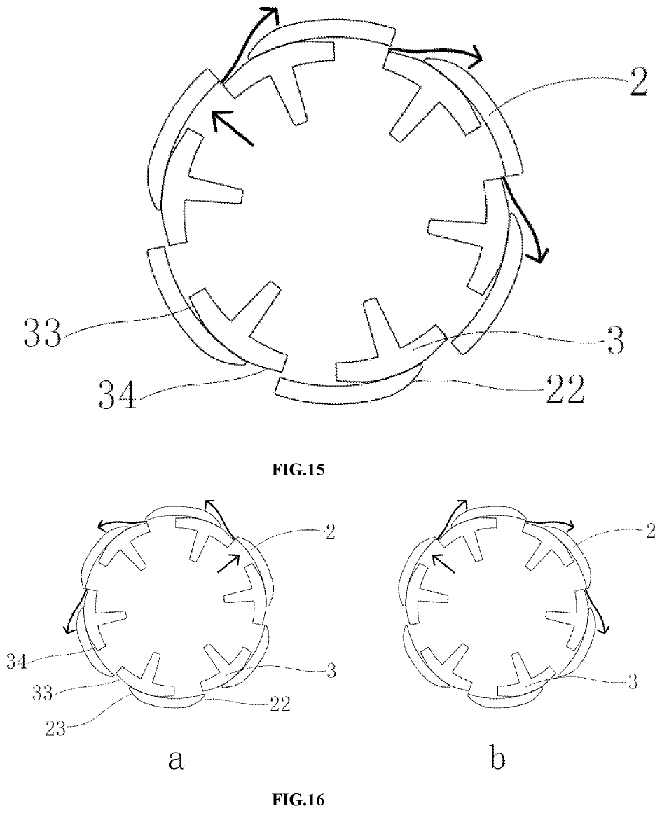

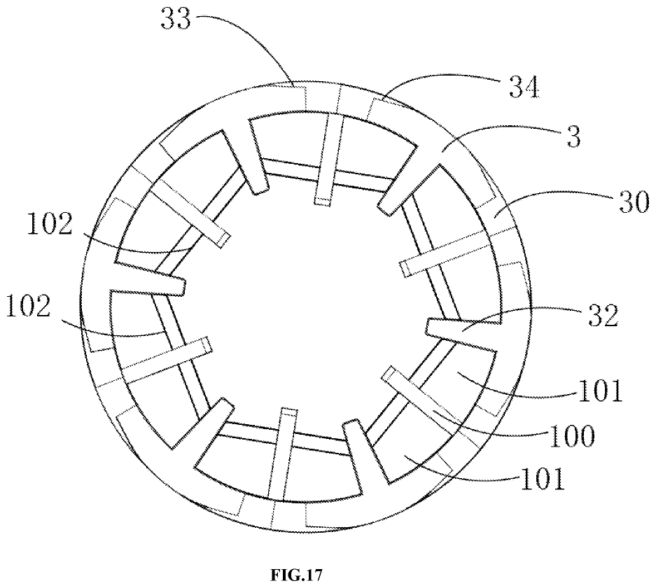

As shown in FIGS. 1-17, a guide structure for an air-suction nozzle provided by the present disclosure includes a main body and guide combs 1 built in the main body, where the main body is provided with a plurality of first air outlets 30, and a plurality of transverse guide fins 101 are formed along a length direction the guide combs 1. One transverse guide fin 101 corresponds to one first air outlet, and the transverse guide fins 101 are configured to limit the turbulent air flow between different first air outlets 30.

In the present disclosure, the guide combs 1 are arranged to guide and divert the air flow entering the main body, and the transverse guide fins 101 restrict the turbulent air flow between different first air outlets 30, resulting in that the air flow from each first air outlet 30 is more even and noise is reduced.

In this embodiment, the guide combs 1 are provided with longitudinal guide connecting strips 100, and the transverse guide fins 101 are connected to the longitudinal guide connecting strips 100. The number of the longitudinal guide connecting strips 100 may be configured to be one or more, and when the number of the longitudinal guide connecting strips 100 is arranged to be one, a plurality of the transverse guide fins 101 can be distributed on both sides or one side of the longitudinal guide connecting strip 100; and when a plurality of the longitudinal guide connecting strips 100 are arranged, a plurality of the transverse guide fins 101 can be distributed between the longitudinal guide connecting strips 100.

A plurality of the guide combs 1 are arranged, the main body is provided with a plurality of air outlet areas arranged side by side, each air outlet area is provided with a plurality of the first air outlets 30 arranged side by side, one guide comb 1 is arranged in one air outlet area, and each transverse guide fin 101 on the guide comb 1 corresponds to each first air outlet 30 in the air outlet area one by one.

In this embodiment, shunting barrier strips 32 are arranged on both left and right sides of each air outlet area, and two adjacent shunting barrier strips 32 form an inner buckle-type accommodating slot 320 for accommodating the guide combs 1. By arranging the shunting barrier strips 32, the air flow from each air outlet area is more even.

In an optional implementation solution, the main body includes main housings 2 and choke assemblies 3, where the main housing 2 is provided with a first air inlet channel 20 and second air outlets 21 connected to the first air inlet channel 20, and the choke assembly 3 is provided with the first air outlets 30 and a second air inlet channel 31 connected to the first air outlets 30. The guide combs 1 are built in the second air inlet channel 31 of the choke assembly 3, the choke assembly 3 can be rotatably installed in the first air inlet channel 20 of the main housing 2, and the rotating choke assembly 3 is capable to block a left or right side of the second air outlet 21, so that air flows out from the left or right side of the second air outlet 21. In another optional implementation solution, in order to reduce wear caused by rotation, the choke assembly 3 can also be fixedly installed in the first air inlet channel 20 of the main housing 2, and the second air outlet 21 arranged on the main housing 2 overall is configured to guide the air flow only along a surface of the main housing 2 in a counterclockwise or clockwise direction, that is, there are two types of the main housing 2, with one being the second air outlet 21 for counterclockwise guide, and the other being the second air outlet 21 for clockwise guide. Two different types of main housings 2 are assembled with the choke assemblies 3 and the guide combs 1 respectively to form two functional air-suction nozzles available for selection by people.

The guide structure is inserted into the body of a hair dryer (not shown in the figures) and can be detachably connected to the body of the hair dryer, serving as an air outlet end. The air is blown out from the body of the hair dryer and then transferred to the main body of the guide structure. First, the air flows into the second air inlet channel 31, under the action of the guide comb 1 and the transverse guide fin 101, the air evenly flows out from the left or right side of the first air outlet 30, and when the choke assembly 3 rotates, a wall body of the choke assembly 3 is capable to block the left or right side of the second air outlet 21, so that the air flows out from the first air outlet 30 to the right or left side of the second air outlet 21. More specifically, the main housing 2 is provided with a first air outlet slope 22 and/or a second air outlet slope 23 formed at a position of the second air outlet 21, and the air flown out of the second air outlet 21 is guided to flow along a wall body of the main housing 2 in the clockwise or counterclockwise direction, so that hair can be automatically twined around an outer wall surface of the main housing 10 in a corresponding direction.

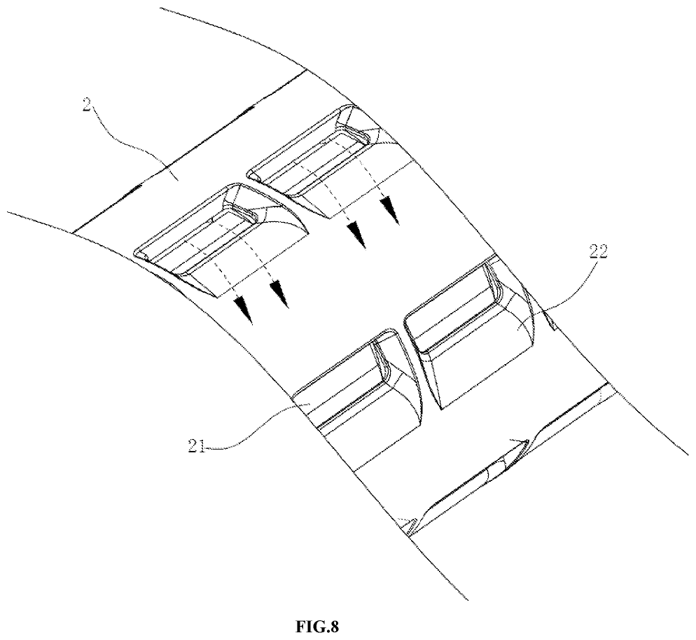

The first air outlet slope 22 and the second air outlet slope 23 can be respectively arranged on the right and left sides of the second air outlet 21 simultaneously, and alternatively, as shown in FIG. 8, the first air outlet slope 22 can be arranged only on the right side of the second air outlet 21, or as shown in FIG. 9, the second air outlet slope 23 can be arranged only on the left side of the second air outlet 21.

In this embodiment, a first inclined air guide surface of the choke assembly 3 is formed at a position of the first air outlet 30, and the first inclined air guide surface includes a first air guide slope 33 configured for guiding air to flow out from a left side of the first air outlet 30 and/or a second air guide slope 34 configured for guiding air to flow out from a right side of the first air outlet 30.

Specifically, both the first air guide slope 33 and the second air guide slope 34 are arranged to guide the air flow from the first air outlet 30, so that the air flow from the second air outlet 21 is more concentrated. In order to better understand the working principle of the present disclosure, dotted lines are used to illustrate the air flow directions, as shown in FIGS. 8-9.

When the choke assembly 3 is fixedly installed in the first air inlet channel 20 of the main housing 2, and when the second air outlet 21 arranged on the main housing 2 overall is configured to guide the air flow only along the surface of the main housing 2 in a counterclockwise or clockwise direction, the air will directly flow out from the first air outlet 30 to the second air outlet 21 along the first air outlet slope 22 or the second air outlet slope 23.

Specifically, the choke assembly 3 and the main housing 2 can be arranged simultaneously, and the main housing 2 also plays a role of heat insulation. In order to save costs, the choke assembly 3 can be removed, the shunting barrier strips 32 can be arranged on an inner wall of the main housing 2, and only the first air outlet slope 22 or the second air outlet slope 23 can be arranged on the second air outlet 21 of the main housing 2.

Specifically, a flow choking surface of the choke assembly 3 is formed at the position of the first air outlet 30, and the flow choking surface includes a first flow choking surface 35 located on an upper side of the first air outlet 30 and/or a second flow choking surface 36 located on a lower side of the first air outlet 30. Specifically, a reference plane of the first flow choking surface 35 and/or the second flow choking surface 36 is tangent to an air inlet direction of the second air inlet channel, and the first flow choking surface 35 and the second flow choking surface 36 are arranged to block the air flow from the upper and lower sides of the first air outlet 30.

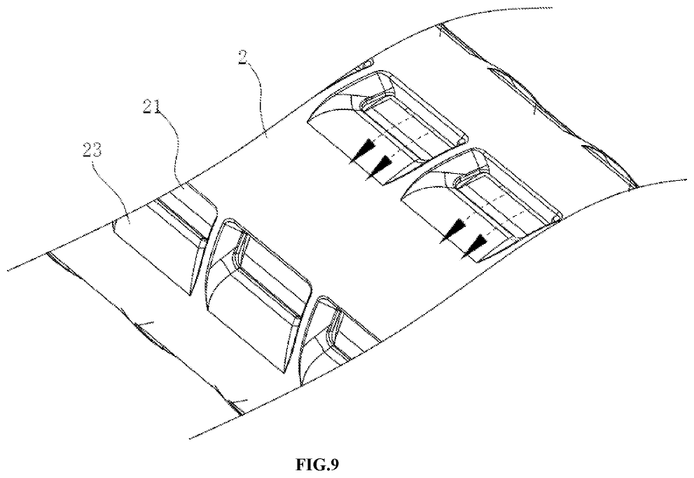

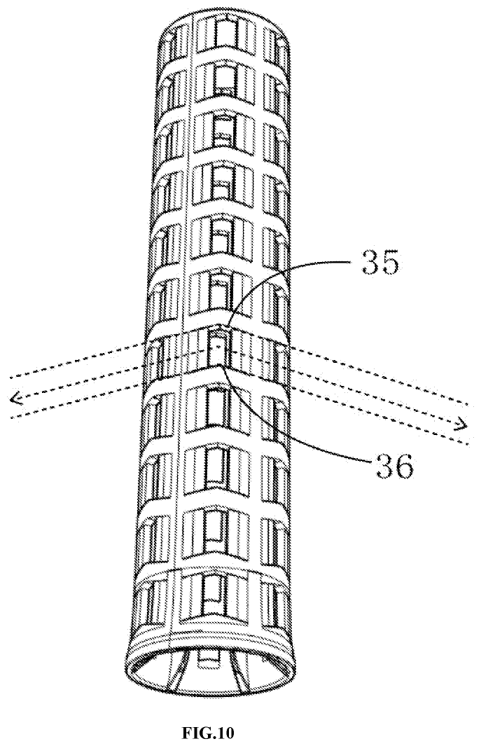

Further, the first flow choking surface 35 and the second flow choking surface 36 form an inverted V-shape, and as shown in FIG. 10, this structure results in that the air flowing out spirals around a wall surface of the main body towards an air inlet end.

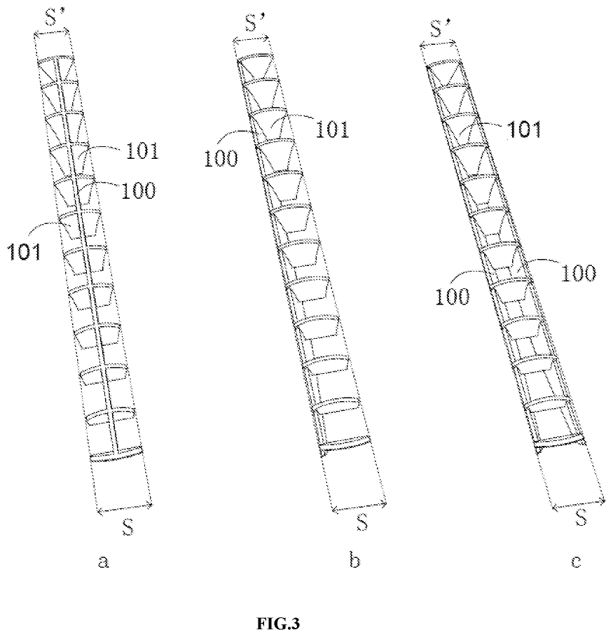

In this embodiment, as shown in FIG. 3, one end of the main body is configured as an air inlet end, a length of a transverse guide fin 101 is set as S, and the length S of a transverse guide fin 101 on a side near the air inlet end is greater than the length S′ of that on the side far from the air inlet end, so that each guide comb 1 can be smoothly inserted and fixed in the accommodating slot 320. As shown in FIG. 11, a spacing between the transverse guide fins 101 of two adjacent guide combs 1 near the air inlet end is configured to be L, and the spacing between the transverse guide fins 101 of two adjacent guide combs 1 far from the air inlet end is configured to be L′, where L>L′. The transverse guide fins 101 are in a shape of an arc bending upward. This structure ensures that the air flow between the first air outlets 30 is relatively more even, that is, the air quickly flows into the inlet channel from the air inlet end, and more air will be blown out from gaps between the parts far from the air inlet end. Because the spacing L′ between two opposite guide fins 1 is smaller, as shown in FIG. 17, the transverse guide fins 101 centrally distributed and enclosed form hexagonal shunt rings 102. Therefore, the transverse guide fins 101 enclosed on a same cross section form a corresponding shunt ring 102 with a diameter of L′, and the shunt rings 102 are downsized layer by layer, to reduce the air flow far from the air inlet end.

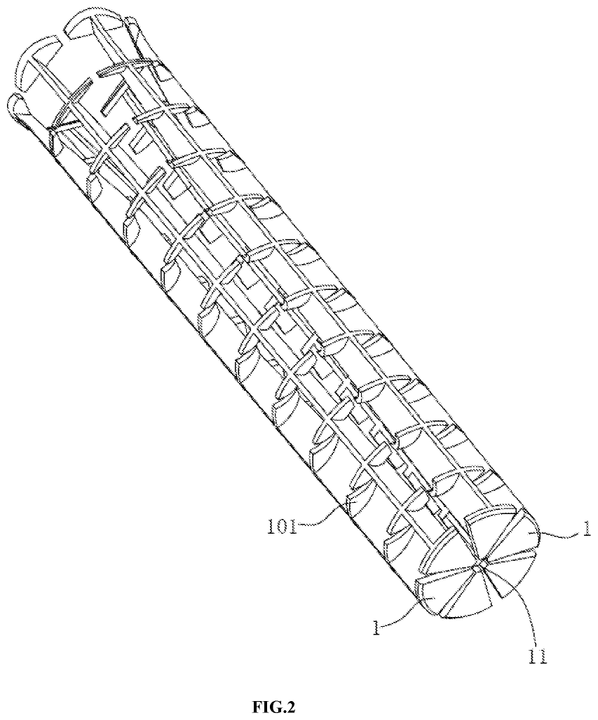

In a further technical solution, as shown in FIG. 2, when a plurality of the guide combs 1 are inserted and fixed in the accommodating slot 320, centers of end walls of the plurality of the guide combs 1 far from the air inlet end are left empty and spliced to form a clearance hole site 11 for a screw rod to pass through, thereby limiting the guide combs 1 to be pulled out of the accommodating slot 320.

In this embodiment, the guide structure further includes turncaps (not shown in the figures), both the main housing 2 and the choke assembly 3 are configured to be in a cylindrical shape, and the turncaps, by means of the screw rod, drives the choke assembly 3 to rotate relative to the main housing 2. In another feasible implementation solution, the turncaps can also be fixed to only play a role of grasping a leverage point.

In this embodiment, each of the shunting barrier strips 32 is formed by extending and protruding from an inner wall of the choke assembly 3 to an inner cavity of the same.

The foregoing descriptions are merely preferred embodiments of the present disclosure. Various modifications can be made by those of ordinary skill in the art to specific implementation modes and their application scopes in accordance with the ideas of the present disclosure. In conclusion, the content of the description shall not be construed as limitation to the present disclosure.

What is claimed is:

1. A guide structure for an air-suction nozzle, comprising:
a main body and guide combs (1) built in the main body, wherein the main body is provided with a plurality of first air outlets (30), and a plurality of transverse guide fins (101) are formed along a length direction the guide combs (1); one transverse guide fin (101) corresponds to one first air outlet (30), and the transverse guide fins (101) are configured to limit the turbulent air flow between different first air outlets (30);
a plurality of the guide combs (1) are arranged, the main body is provided with a plurality of air outlet areas arranged side by side, each air outlet area is provided with a plurality of the first air outlets (30) arranged side by side, at least one guide comb (1) is arranged in one air outlet area, and one first air outlet (30) at least corresponds to one transverse guide fin (101); and
shunting barrier strips (32) are arranged on both left and right sides of each air outlet area, and two adjacent shunting barrier strips (32) form an inner buckle-type accommodating slot (320) for accommodating the guide combs (1).

2. The guide structure for an air-suction nozzle according to claim 1, wherein the guide combs (1) are provided with longitudinal guide connecting strips (100), and the transverse guide fins (101) are connected to the longitudinal guide connecting strips (100).

3. The guide structure for an air-suction nozzle according to claim 2, wherein the number of the longitudinal guide connecting strips (100) is configured to be one or more,
the number of the longitudinal guide connecting strips (100) is arranged to be one, a plurality of the transverse guide fins (101) can be distributed on both sides or one side of the longitudinal guide connecting strip (100); and
when a plurality of the longitudinal guide connecting strips (100) are arranged, a plurality of the transverse guide fins (101) can be distributed between the longitudinal guide connecting strips (100).

4. The guide structure for an air-suction nozzle according to claim 1, wherein one end of the main body is configured as an air inlet end, a spacing between the transverse guide fins (101) on the two opposite guide combs (1) near the air inlet end is configured to be L, and the spacing between the transverse guide fins (101) on the two opposite guide combs (1) far from the air inlet end is configured to be L′, wherein L>L′.

5. The guide structure for an air-suction nozzle according to claim 1, wherein the transverse guide fins (101) are in a shape of an arc bending upward.

6. The guide structure for an air-suction nozzle according to claim 1, wherein the main body comprises main housings (2) and choke assemblies (3), wherein the main housing (2) is provided with a first air inlet channel (20) and second air outlets (21) connected to the first air inlet channel (20), and the choke assembly (3) is provided with the first air outlets (30) and a second air inlet channel (31) connected to the first air outlets (30). The guide combs (1) are built in the second air inlet channel (31) of the choke assembly, and the choke assembly (3) is arranged in the first air inlet channel (20) of the main housing (2).

7. The guide structure for an air-suction nozzle according to claim 6, wherein the choke assembly (3) can be rotatably installed in the first air inlet channel (20) of the main housing (2), and the rotating choke assembly (3) is capable to block a left or right side of the second air outlet (21), so that air flows out from a right or left side of the second air outlet (21).

8. The guide structure for an air-suction nozzle according to claim 6, wherein a first inclined air guide surface of the choke assembly (3) is formed at a position of the first air outlet (30), and the first inclined air guide surface comprises a first air guide slope (33) configured for guiding air to flow out from a left side of the first air outlet (30) and/or a second air guide slope (34) configured for guiding air to flow out from a right side of the first air outlet (30).

9. The guide structure for an air-suction nozzle according to claim 6, wherein a flow choking surface of the choke assembly (3) is formed at the position of the first air outlet (30), and the flow choking surface comprises a first flow choking surface (35) located on an upper side of the first air outlet (30) and/or a second flow choking surface (36) located on a lower side of the first air outlet (30).

10. The guide structure for an air-suction nozzle according to claim 9, wherein the first flow choking surface (35) and the second flow choking surface (36) form an inverted V-shape, resulting in that the air flowing out of the first air outlet (30) spirals around a wall surface of the main body (1) towards the air inlet end.

11. The guide structure for an air-suction nozzle according to claim 6, wherein a first air outlet slope (22) configured for guiding air to flow out from the left side of the second air outlet (21) and/or a second air outlet slope (23) configured for guiding air to flow out from the right side of the second air outlet (21) are formed at the position of the second air outlet (21) of the main housing (2).

12. The guide structure for an air-suction nozzle according to claim 1, wherein when a plurality of the guide combs (1) are inserted and fixed in the accommodating slot (320), centers of end walls of the plurality of the guide combs (1) far from the air inlet end are left empty and spliced to form a clearance hole site (11) for a screw rod to pass through.
